(19) United States
(12) Patent Application Publication
(10) Pub. No.: US 2026/0076311 A1
(43) Pub. Date: Mar. 19, 2026

(54) CRANKSHAFT FOR HANDHELD POWER TOOLS

(71) Applicant: Milwaukee Electric Tool Corporation, Brookfield, WI (US)

(72) Inventor: Kevin S. Puls, Milwaukee, WI (US)

(21) Appl. No.: 19/320,617

(22) Filed: Sep. 5, 2025

Related U.S. Application Data
(60) Provisional application No. 63/696,401, filed on Sep. 19, 2024.

(51) Int. Cl. A01G 3/053; A01G 3/04; F16C 3/06

(52) U.S. Cl. CPC A01G 3/053; F16C 3/06; A01G 2003/0461

(57) ABSTRACT

A crankshaft assembly is provided. The crankshaft assembly includes a crankshaft including a first engaging member and a second engaging member. The second engaging member is spaced from the first engaging member in a direction of a rotational axis of the crankshaft. A first center point of the first engagement member is offset from a second center point of the second engagement member an offset angle defined about the rotational axis. The offset angle is 270°.

### CROSS-REFERENCE TO RELATED APPLICATIONS

This application claims priority to U.S. Provisional Ser. No. 63/696,401, filed Sep. 19, 2024, the entire contents of which are incorporated herein by reference.

### FIELD

The present disclosure relates generally to crankshaft mechanisms and handheld power tools, such as hedge trimmers, with crankshaft mechanisms.

### BACKGROUND

Typically, handheld power tools such as hedge trimmers and chainsaws operate using a crankshaft to convert the rotational motion of a small engine into translational motion. These mechanisms allow the handheld power tools to effectively cut through objects or perform other desired tasks. The translational motion may produce undesirable vibrations. Accordingly, improved crankshaft mechanisms are desired in the art. In particular, crankshafts that reduce vibrations would be advantageous.

### BRIEF DESCRIPTION

Aspects and advantages of the present disclosure will be set forth in part in the following description, or may be obvious from the description, or may be learned through practice of the technology.

In accordance with one embodiment, a handheld power tool is provided. The handheld power tool includes a first reciprocating element, a second reciprocating element, and a crankshaft. The crankshaft includes a first engaging member and a second engaging member. The second engaging member is spaced from the first engaging member in a direction of a rotational axis of the crankshaft. The handheld power tool also include a first connecting rod extending between a first end and a second end opposite the first end and a second connecting rod extending between the first end and the second end. The first connecting rod is coupled between the first engaging member of the crankshaft and the first reciprocating element, and the second connecting rod is coupled between the second engaging member of the crankshaft and the second reciprocating element. A first center point of the first engagement member adjacent the first end is offset from a second center point of the second engagement member adjacent the first end an offset angle defined about the rotational axis. The offset angle is greater than 180°.

In accordance with another embodiment, a crankshaft assembly is provided. The crankshaft assembly includes a crankshaft including a first engaging member and a second engaging member. The second engaging member is spaced from the first engaging member in a direction of a rotational axis of the crankshaft. A first center point of the first engagement member is offset from a second center point of the second engagement member an offset angle defined about the rotational axis. The offset angle is greater than 180°.

In accordance with yet another embodiment, a method of assembling a handheld power tool is provided. The method includes providing a crankshaft including a first engaging member and a second engaging member, coupling a first end of a first connecting rod to the first engaging member, coupling a first end of a second connecting rod to the second engaging member such that a first center point of the first engaging member adjacent the first end is offset from a second center point of the second engaging member adjacent the first end an offset angle about a rotational axis of the crankshaft, coupling a first reciprocating element to a second end of the first connecting rod opposite the first end, and coupling a second reciprocating element to a second end of the second connecting rod opposite the first end. The offset angle is greater than 180°.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a hedge trimmer in accordance with embodiments of the present disclosure;

FIG. 2 is a detailed, cross-sectional view of the hedge trimmer of FIG. 1 in accordance with embodiments of the present disclosure;

FIG. 3 is a perspective view of a crankshaft assembly in accordance with embodiments of the present disclosure;

FIG. 4 is a detailed view of the crankshaft assembly of FIG. 3 in accordance with embodiments of the present disclosure;

FIG. 5A is a top view of the crankshaft assembly of FIG. 3 in accordance with embodiments of the present disclosure;

FIG. 5B is a top, schematic view of the crankshaft assembly of FIG. 5A in accordance with embodiments of the present disclosure; and

FIG. 6 is a flow chart of a method of assembling a handheld power tool.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, handheld power tools include a crankshaft for translating rotational motion from a motive device, such as an elective motor, into translational motion. For example, the crankshaft may include first and second engagement members for translating the rotational motion to translational motion of two or more reciprocating elements. The translational motion of the reciprocating elements may create secondary vibrations within the handheld power tool. Offsetting a center of each of the first and second engaging members of the crankshaft may reduce such secondary vibrations.

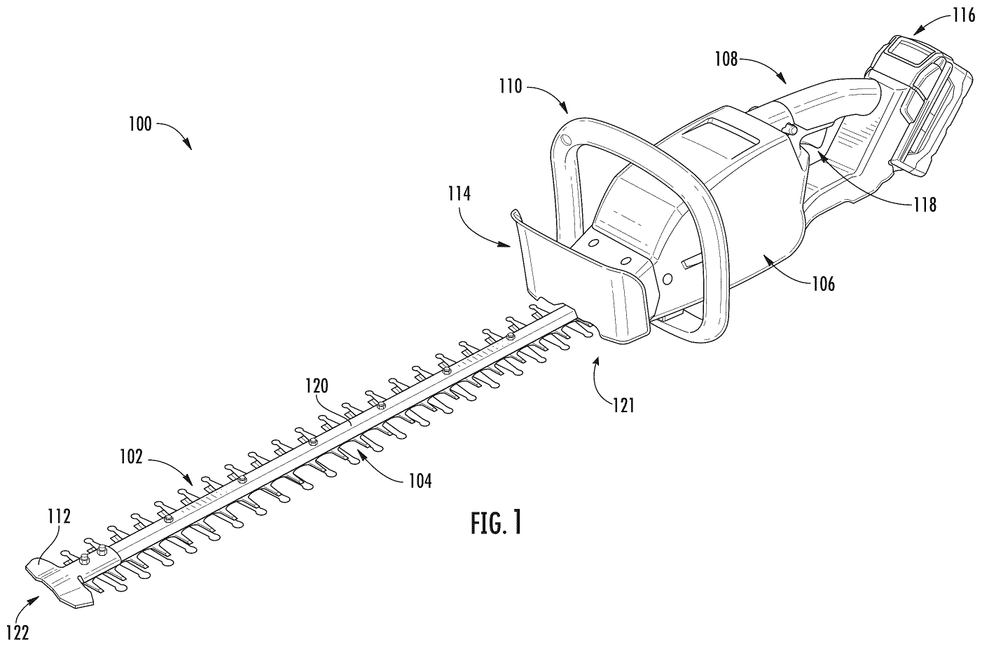

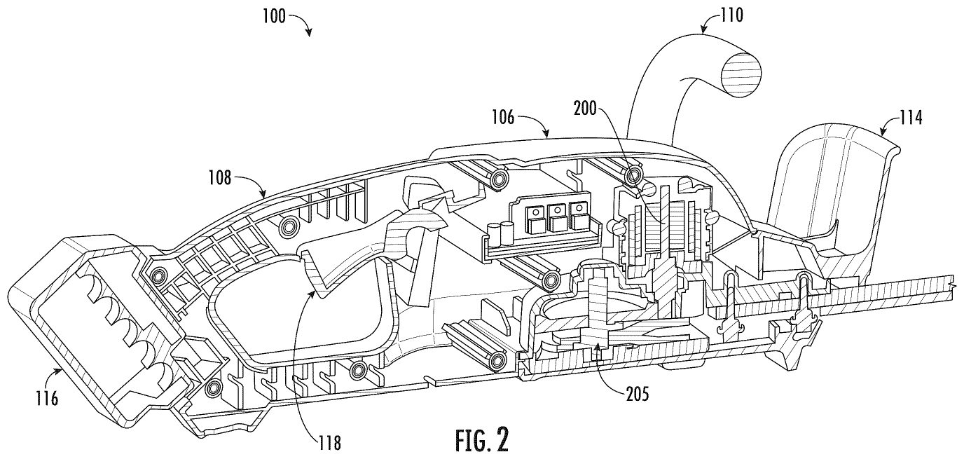

Referring now to the drawings, FIG. 1 illustrates a perspective view of a hedge trimmer in accordance with embodiments of the present disclosure. FIG. 2 illustrates a detailed, cross-sectional view of the hedge trimmer of FIG. 1 in accordance with embodiments of the present disclosure. More particularly, FIGS. 1 and 2 illustrate a hedge trimmer 100 in accordance with an embodiment of the present disclosure. The hedge trimmer 100 generally includes at least one reciprocating cutting implement. For example, the hedge trimmer 100 may include a first reciprocating element, such as a first blade 102, and a second reciprocating element, such as a second blade 104, extending from a first end 121 to a second end 122 opposite the first end 121. The first blade 102 and the second blade 104 include “teeth” which, when the implements are reciprocated, cause the blades to cut into material, such as branches of hedges. In other example embodiments, only one of the first blade 102 and the second blade 104 are configured to reciprocate. For example, one of the first blade 102 and the second blade 104 may remain stationary while the other of the first blade 102 and the second blade 104 reciprocates to cause the blades to cut into the material.

The hedge trimmer 100 may further include a housing 106. The first blade 102 and the second blade 104 may extend from the housing 106. Moreover, the first blade 102 and the second blade 104 of the hedge trimmer 100 may be coupled to a spine 120 extending from the housing 106 for supporting the first blade 102 and the second blade 104. The hedge trimmer 100 may include a handle 108. In some example embodiments, the hedge trimmer 100 may further include a secondary handle 110. The hedge trimmer 100 may further include a blade tip guard 112. The blade tip guard 112 may be coupled to a portion of the spine 120 adjacent the second end 122 and configured to prevent the blades located furthest from the housing 106 from contact with objects (e.g., fences, siding, etc.). The hedge trimmer 100 may further include a blade guard 114. Blade guard 114 may be configured to stop flying debris from hitting the operator.

As shown in FIG. 2, the hedge trimmer 100 may also include a motive device 200, such as an electric motor or gas powered engine, which drives a crankshaft 205. For example, the motive device 200 may be disposed within the housing 106. The crankshaft 205, as will be discussed in further detail below, may be engaged with the first blade 102 and the second blade 104 such that rotation of the crankshaft causes the first blade 102 and the second blade 104 to reciprocate. While the crankshaft 205 is discussed with respect to the hedge trimmer 100, it should be understood that the crankshaft 205 may be utilized with other power tools, such as reciprocating saws, oscillating saws (or multi-tools), reciprocating scissors, compressors, dual action sanders, and jig saws.

With reference to FIGS. 1-2, the motive device 200 may be powered, for example, by a rechargeable energy source such as a battery 116, a fuel source such as gasoline, or the like. In the depicted example embodiment, the hedge trimmer 100 includes an actuator 118. The actuator 118 is disposed proximate to the handle 108. When depressed, the actuator 118 may engage the motive device to cause the first blade 102 and the second blade 104 to move. As the actuator 118 is depressed further, a speed of the motive device can increase from zero speed to a maximum speed. In this regard, the actuator 118 may variably affect the speed of the motive device between a stopped speed, which occurs when the actuator 118 is not depressed, and a maximum speed, which occurs when the actuator 118 is fully depressed.

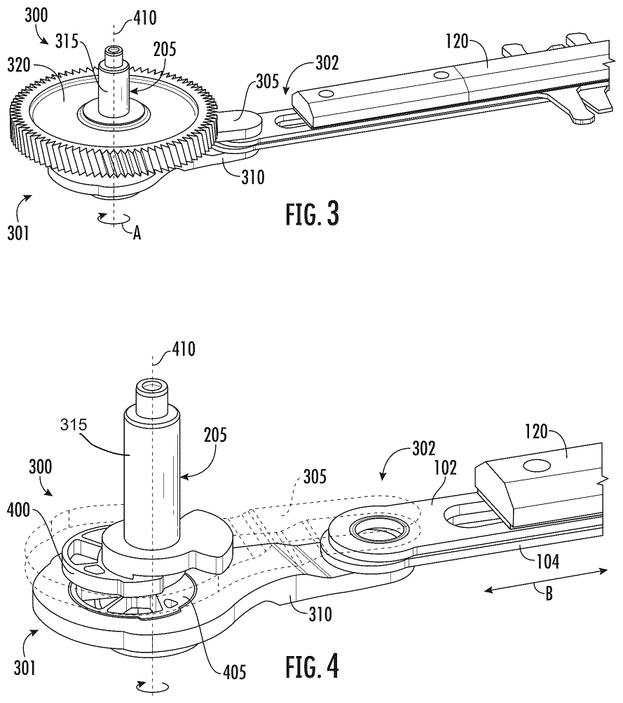

FIG. 3 illustrates a perspective view of a crankshaft assembly 300 in accordance with embodiments of the present disclosure. FIG. 4 illustrates a detailed view of the crankshaft assembly 300 of FIG. 3 in accordance with embodiments of the present disclosure.

The crankshaft assembly 300 includes the crankshaft 205, a first connecting rod 305, and a second connecting rod 310. The first connecting rod 305 and the second connecting rod 310 extend between a first end 301 and a second end 302 opposite the first end 301. The second end 302 of the first connecting rod 305 is configured to be coupled to the first blade 102 and the second end 302 of the second connecting rod 310 is configured to be coupled to the second blade 104.

The crankshaft 205 includes an input shaft 315 configured to be coupled to the motive device 200. Additionally, as shown in FIG. 3, at least one gear 320 may be coupled to the input shaft 315 for transferring rotational motion from the motive device 200 to drive rotation of the input shaft 315.

With reference to FIG. 4, which illustrates the crankshaft assembly 300 with the at least one gear 320 removed, the crankshaft 205 includes a first engaging member 400 and a second engaging member 405 coupled to and configured to rotate with the input shaft 315. The second engaging member 405 may be spaced from the first engaging member 400 in a direction of a rotational axis 410 of the crankshaft 205. Accordingly, the input shaft 315, the first engaging member 400, and the second engaging member 405 are configured to rotate about the rotational axis 410.

The first end 301 of the first connecting rod 305 is configured to be coupled to the first engaging member 400 and the first end 301 of the second connecting rod 310 is configured to be coupled to the second engaging member 405. The first engaging member 400 and the second engaging member 405 are configured to drive the first blade 102 and the second blade 104 via the first connecting rod 305 and the second connecting rod 310. For example, as the crankshaft 205 rotates about the rotational axis 415 in a first direction A, the first engaging member 400 and the second engaging member 405 translate the rotational motion to linear motion such that the first blade 102 and the second blade 104 are reciprocated in a second direction B perpendicular to the rotational axis 415 via the first connecting rod 305 and the second connecting rod 310.

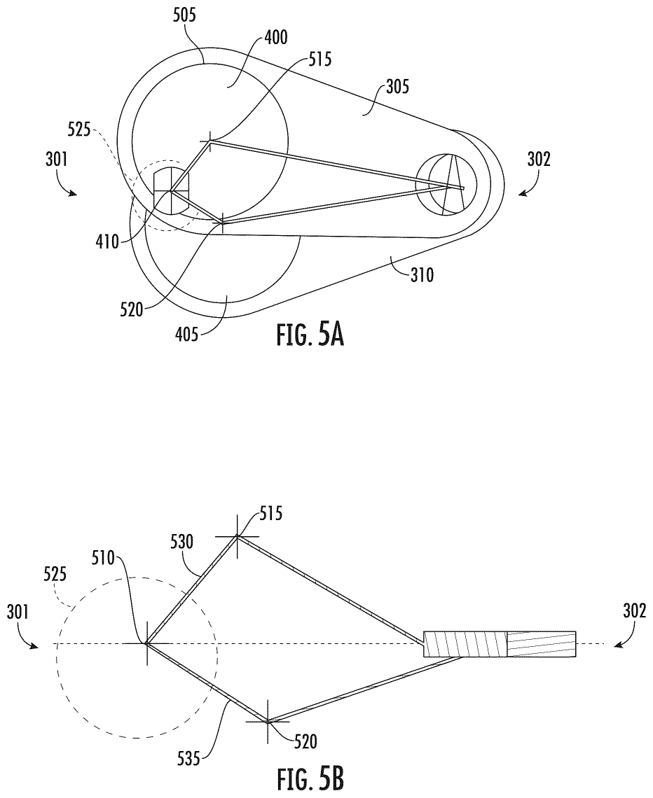

FIG. 5A illustrates a top view of the crankshaft assembly 300 of FIG. 3 in accordance with embodiments of the present disclosure. FIG. 5B illustrates a top, schematic view of the crankshaft assembly 300 of FIG. 5A in accordance with embodiments of the present disclosure.

As shown in FIG. 5A, the first end 301 of the first connecting rod 305 defines a first engagement opening 505 and the first end 301 of the second connecting rod 310 defines a second engagement opening 510. The first engagement opening 505 and the second engagement opening 510 are configured to receive the first engagement member 400 and the second engagement member 405, respectively.

Moreover, the first engaging member 400 defines a first center point 515 and the second engaging member 405 defines a second center point 520. The first center point 515 may also be at a center of the first engagement opening 505 and the second center point 520 may also be at a center of the second engagement opening 510. The first center point 515 and the second center point 520 are offset from the input shaft 315 and the rotational axis 410 and configured to rotate about the rotational axis 410.

The first center point 515 may be offset from the second center point 520 an offset angle 525. For example, with reference to FIG. 5B, a first reference line 530 extends between the first center point 515 of the first engaging member 400 to the rotational axis 410, and a second reference line 535 extends from the second center point 520 of the second engaging member 404 to the rotational axis 410. The offset angle 525 may be defined about the rotational axis 410 between the first reference line 530 and the second reference line 535. In at least one example embodiment, the offset angle 525 may be greater than about 180°. For example, the offset angle 525 may be greater than or equal to about 260° and less than or equal to about 280°. More specifically, the offset angle 525 may be 270°.

Offsetting the first center point 515 of the first engaging member 400 and the second center point 520 of the second engaging member 405 of the crankshaft 205 may reduce vibrations caused by motion of the first connecting rod 305 and the second connecting rod 310. Moreover, any imbalance caused by offsetting the first center point 515 and the second center point 520 by offset angle 525 may offset by counterweights and/or countershafts.

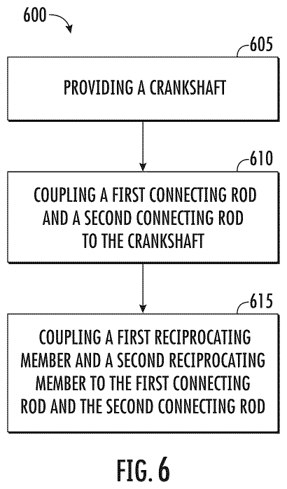

FIG. 6 is a flow chart of a method 600 of assembling a handheld power tool. More specifically, the method 600 of assembling the handheld power tool may include assembling the crankshaft assembly 300 of the hedge trimmer 100.

In at least one example embodiment, the method 600 includes providing a crankshaft at 605, coupling a first connecting rod and a second connecting rod to the crankshaft at 610, and coupling a first reciprocating member and a second reciprocating member to the first connecting rod and the second connecting rod at 615.

Providing a crankshaft at 605 may include providing the crankshaft 205 of the crankshaft assembly 300. For example, the crankshaft 205 includes the input shaft 315, the first engaging member 400 coupled to the input shaft 315, and the second engaging member 405 coupled to the input shaft 315. As discussed with respect to FIGS. 5A-5B, the first engaging member 400 defines the first center point 515 and the second engaging member 405 defines the second center point 520. Accordingly, the first center point 515 of the first engaging member 400 and the second center point 520 of the second engaging member 405 may be offset the offset angle 525.

Coupling a first connecting rod and a second connecting rod to the crankshaft at 610 may include coupling the first connecting rod 305 and the second connecting rod 310 to the crankshaft 205. For example, the first connecting rod 305 may be coupled to the first engaging member 400 and the second connecting rod may be coupled to the second engaging member 405. As discussed with respect to FIGS. 5A-5B, the first engagement opening 505 defined by the first connecting rod 305 and the second engagement opening 510 defined by the second connecting rod 310 are configured to receive the first engagement member 400 and the second engagement member 405, respectively. Accordingly, the first center point 515 may also be at a center of the first engagement opening 505 and the second center point 520 may also be at a center of the second engagement opening 510 such that a center of the first engagement opening 505 and a center of the second engagement opening 510 are offset the offset angle 525.

Coupling a first reciprocating member and a second reciprocating member to the first connecting rod and the second connecting rod at 615 includes coupling the first blade 102 to the first connecting rod 305 and coupling the second blade 104 to the second connecting rod 310.

Further aspects of the disclosure are provided by one or more of the following embodiments:

A handheld power tool, comprising: a first reciprocating element; a second reciprocating element; a crankshaft comprising a first engaging member and a second engaging member, the second engaging member spaced from the first engaging member in a direction of a rotational axis of the crankshaft; a first connecting rod extending between a first end and a second end opposite the first end, the first connecting rod coupled between the first engaging member of the crankshaft and the first reciprocating element; and a second connecting rod extending between the first end and the second end, the second connecting rod coupled between the second engaging member of the crankshaft and the second reciprocating element; wherein a first center point of the first engagement member adjacent the first end is offset from a second center point of the second engagement member adjacent the first end an offset angle defined about the rotational axis; and wherein the offset angle is greater than 180°.

The handheld power tool of any one or more of the embodiments, wherein the offset angle is 270°.

The handheld power tool of any one or more of the embodiments, wherein: the first end of the first connecting rod is coupled to the first engaging member of the crankshaft; and the first end of the second connecting rod is coupled to the second engaging member of the crankshaft.

The handheld power tool of any one or more of the embodiments, wherein: the first end of the first connecting rod defines a first engagement opening; and the first end of the second connecting rod defines a second engagement opening.

The handheld power tool of any one or more of the embodiments, wherein: the first engagement opening is configured to receive the first engaging member of the crankshaft; and the second engagement opening is configured to receive the second engaging member of the crankshaft.

The handheld power tool of any one or more of the embodiments, wherein: the first center point is defined at a center of the first engagement opening; and the second center point is defined at a center of the second engagement opening.

The handheld power tool of any one or more of the embodiments, further comprising a motive device coupled to the crankshaft for driving rotation of the crankshaft about the rotational axis.

The handheld power tool of any one or more of the embodiments, wherein the first engaging member and the second engaging member are configured to convert rotational motion of the crankshaft about the rotational axis to linear motion of the first reciprocating element and the second reciprocating element.

The handheld power tool of any one or more of the embodiments, wherein: the first reciprocating element comprises a first blade; and the second reciprocating element comprises a second blade.

The handheld power tool of any one or more of the embodiments, wherein the handheld power tool comprises a hedge trimmer.

The handheld power tool of any one or more of the embodiments, wherein the handheld power tool comprises a reciprocating saw, an oscillating saw, reciprocating scissors, a compressor, a dual action sander, or a jig saw.

A crankshaft assembly for a handheld power tool, comprising: a crankshaft comprising a first engaging member and a second engaging member, the second engaging member spaced from the first engaging member in a direction of a rotational axis of the crankshaft; wherein a first center point of the first engagement member is offset from a second center point of the second engagement member an offset angle defined about the rotational axis; and wherein the offset angle is greater than 180°.

The crankshaft assembly of any one or more of the embodiments, wherein the offset angle is 270°.

The crankshaft assembly of any one or more of the embodiments, wherein the crankshaft comprises a first connecting rod extending between a first end and a second end opposite the first end and a second connecting rod extending between the first end and the second end.

The crankshaft assembly of any one or more of the embodiments, wherein: the first end of the first connecting rod defines a first engagement opening; and the first end of the second connecting rod defines a second engagement opening.

The crankshaft assembly of any one or more of the embodiments, wherein: the first engagement opening is configured to receive the first engaging member of the crankshaft; and the second engagement opening is configured to receive the second engaging member of the crankshaft.

The crankshaft assembly of any one or more of the embodiments, wherein: the first center point is defined at a center of the first engagement opening; and the second center point is defined at a center of the second engagement opening.

The crankshaft assembly of any one or more of the embodiments, wherein the first engaging member and the second engaging member are configured to convert rotational motion of the crankshaft about the rotational axis to linear motion of the first connecting rod and the second connecting rod.

The crankshaft assembly of any one or more of the embodiments, further comprising a motive device coupled to the crankshaft for driving rotation of the crankshaft about the rotational axis.

The crankshaft assembly of any one or more of the embodiments, wherein: a second end of the first connecting rod opposite the first end is configured to be coupled to a first reciprocating element; and a second end of the second connecting rod opposite the first end is configured to be coupled to a second reciprocating element.

The crankshaft assembly of any one or more of the embodiments, wherein: the first reciprocating element comprises a first blade; and the second reciprocating element comprises a second blade.

A method of assembling a handheld power tool, comprising: providing a crankshaft including a first engaging member and a second engaging member; coupling a first end of a first connecting rod to the first engaging member; coupling a first end of a second connecting rod to the second engaging member such that a first center point of the first engaging member adjacent the first end is offset from a second center point of the second engaging member adjacent the first end an offset angle about a rotational axis of the crankshaft; coupling a first reciprocating element to a second end of the first connecting rod opposite the first end; and coupling a second reciprocating element to a second end of the second connecting rod opposite the first end; wherein the offset angle is greater than 180°.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A handheld power tool, comprising:
a first reciprocating element;
a second reciprocating element;
a crankshaft comprising a first engaging member and a second engaging member, the second engaging member spaced from the first engaging member in a direction of a rotational axis of the crankshaft;
a first connecting rod extending between a first end and a second end opposite the first end, the first connecting rod coupled between the first engaging member of the crankshaft and the first reciprocating element; and
a second connecting rod extending between the first end and the second end, the second connecting rod coupled between the second engaging member of the crankshaft and the second reciprocating element;
wherein a first center point of the first engagement member adjacent the first end is offset from a second center point of the second engagement member adjacent the first end an offset angle defined about the rotational axis; and
wherein the offset angle is greater than 180°.

2. The handheld power tool of claim 1, wherein the offset angle is about 270°.

3. The handheld power tool of claim 1, wherein:
the first end of the first connecting rod is coupled to the first engaging member of the crankshaft; and
the first end of the second connecting rod is coupled to the second engaging member of the crankshaft.

4. The handheld power tool of claim 1, wherein:
the first end of the first connecting rod defines a first engagement opening; and
the first end of the second connecting rod defines a second engagement opening.

5. The handheld power tool of claim 3, wherein:
the first engagement opening is configured to receive the first engaging member of the crankshaft; and
the second engagement opening is configured to receive the second engaging member of the crankshaft.

6. The handheld power tool of claim 1, further comprising a motive device coupled to the crankshaft for driving rotation of the crankshaft about the rotational axis.

7. The handheld power tool of claim 1, wherein the first engaging member and the second engaging member are configured to convert rotational motion of the crankshaft about the rotational axis to linear motion of the first reciprocating element and the second reciprocating element.

8. The handheld power tool of claim 1, wherein:
the first reciprocating element comprises a first blade; and
the second reciprocating element comprises a second blade.

9. The handheld power tool of claim 1, wherein the handheld power tool comprises a hedge trimmer.

10. The handheld power tool of claim 1, wherein the handheld power tool comprises a reciprocating saw, an oscillating saw, reciprocating scissors, a compressor, a dual action sander, or a jig saw.

11. A crankshaft assembly for a handheld power tool, comprising:
a crankshaft comprising a first engaging member and a second engaging member, the second engaging member spaced from the first engaging member in a direction of a rotational axis of the crankshaft;
wherein a first center point of the first engagement member is offset from a second center point of the second engagement member an offset angle defined about the rotational axis; and
wherein the offset angle is greater than 180°.

12. The crankshaft assembly of claim 11, wherein the offset angle is about 270°.

13. The crankshaft assembly of claim 11, wherein the crankshaft comprises a first connecting rod extending between a first end and a second end opposite the first end and a second connecting rod extending between the first end and the second end.

14. The crankshaft assembly of claim 13, wherein:
the first end of the first connecting rod defines a first engagement opening; and
the first end of the second connecting rod defines a second engagement opening.

15. The crankshaft assembly of claim 14, wherein:
the first engagement opening is configured to receive the first engaging member of the crankshaft; and
the second engagement opening is configured to receive the second engaging member of the crankshaft.

16. The crankshaft assembly of claim 13, wherein the first engaging member and the second engaging member are configured to convert rotational motion of the crankshaft about the rotational axis to linear motion of the first connecting rod and the second connecting rod.

17. The crankshaft assembly of claim 13, wherein:
a second end of the first connecting rod opposite the first end is configured to be coupled to a first reciprocating element; and
a second end of the second connecting rod opposite the first end is configured to be coupled to a second reciprocating element.

18. The crankshaft assembly of claim 17, wherein:
the first reciprocating element comprises a first blade; and
the second reciprocating element comprises a second blade.

19. The crankshaft assembly of claim 11, further comprising a motive device coupled to the crankshaft for driving rotation of the crankshaft about the rotational axis.

20. A method of assembling a handheld power tool, comprising:
providing a crankshaft including a first engaging member and a second engaging member;
coupling a first end of a first connecting rod to the first engaging member;
coupling a first end of a second connecting rod to the second engaging member such that a first center point of the first engaging member adjacent the first end is offset from a second center point of the second engaging member adjacent the first end an offset angle about a rotational axis of the crankshaft;
coupling a first reciprocating element to a second end of the first connecting rod opposite the first end; and
coupling a second reciprocating element to a second end of the second connecting rod opposite the first end;
wherein the offset angle is greater than 180°.
